(19) United States
(12) Patent Application Publication
(10) Pub. No.: US 2003/0126193 A1
(43) Pub. Date: Jul. 3, 2003

(54) Method and system for providing synchronization

(76) Inventors: Anders Marklund, Stockholm (SE); Anders Hedlund, Huddinge (SE)

Correspondence Address: HARNESS, DICKEY & PIERCE, P.L.C., P.O. BOX 828, BLOOMFIELD HILLS, MI, 48303, US

(21) Appl. No.: 10/204,770

(22) PCT Filed: Feb. 23, 2001
(86) PCT No.: PCT/SE01/00415

(30) Foreign Application Priority Data
Feb. 25, 2000 (SE) 0000630.4

(51) Int. Cl. G06F 15/173; G06F 15/16

(52) U.S. Cl. 709/202; 709/223

(57) ABSTRACT

In a management system comprising a manager connected to a number of agents a trap table is provided in the agent. Each trap transmitted from the agent to the manager is given an incremented number so that if the manager does not receive a trap, the manager knows which trap to request from the agent using an SNMP get-request message. The information of the trap message can then be fetched from the trap table in the agent and transmitted in a response message to the manager. A trap counter is also provided in the agent. The trap counter is set equal to the number of the last sent trap in connection with the sending of the trap.

### TECHNICAL FIELD

The present invention relates to a method and a system for providing synchronization in the management of power supply units in a telecommunications network.

### BACKGROUND OF THE INVENTION AND PRIOR ART

The U.S. Department of Defense (DOD) has defined two transport level protocols for use together with Internet Protocol (IP). Thus, there is the Transmission Control Protocol (TCP), which is a connection oriented protocol and there is the User Datagram Protocol (UDP), which is a connectionless protocol.

In most cases the TCP is used. However, in some cases UDP is used. The reason for using UDP is that the overhead of the protocol is reduced in comparison to the TCP. Also the TCP protocol requires more bandwidth, which clearly is not wanted since that will make the application heavier.

A problem, however, is due to the connectionless nature UDP which may make the functioning of the application unreliable, i.e. there is no guarantee that delivery has taken place of any message. The reason for this is that since there is no error reporting provided in the UDP, the transmitted data can be lost on the way, and there is no mechanism for detecting the loss. The only error control provided in UDP is the provision of a checksum for making sure that the data received is not altered on the way. Thus, if the checksum is valid the received data is used and otherwise it is discarded.

However, in many applications the use of UDP is faster compared to the use of e.g. TCP or the like and also requires less bandwidth.

A further reason to solve the problem connected with the use of UDP is that in some applications where the UDP has been the protocol used, either as a standardized protocol or as a de facto standard, development of the applications has made the connectionless nature of the UDP a problem. It is difficult and very expensive to change the protocol to, for example, TCP in an existing application.

Still a further reason to solve this problem is the use of UDP-datagram based messages over a SNMP (Simple Network Management Protocol) connection. The reason for using the SNMP is that this is a protocol for control and management. Thus there are several reasons for using the UDP instead of TCP.

One example of such an application is the management of power supply units used in a telecommunications network. In such an application it is common to let a separate supervisor unit collect data regarding the status of all power supply units belonging to the supervisor unit. Then, this information is sent to a central location, which can be termed an agent, where the information from several units is received and stored. In, for example, a region or an entire country, there will be several agents. The agents are in turn supervised by a unit, usually termed a manager.

In order to update the manager with information from the different agents, data is sent by means of a SNMP trap message using UDP datagrams to carry the trap message through the network over a IP connection to the manager.

SNMP uses a fetch-store paradigm to effect operations between a manager and agent. Specifically, SNMP defines get request, get-next request, get-bulk request, get response, and set request messages which provide the basic fetch and store operations. In addition, SNMP defines a trap message with which an agent asynchronously sends information to a manager triggered by an event. Thus, a manager request operational data or receives event notifications by means of this simple set of SNMP message/command.

The manager and the respective agents have access to a Management Information Base (MIB) each, defining the data regarding the status of the different power supply units etc, which may be accessed by the manager through this type of messages. The agents keep the manager updated by means of sending SNMP trap messages. Such messages may be initiated by an event or sent on a schedule. However, as stated above it is possible that this information never reaches the manager due to the nature of the UDP. Thus, there is a problem of how to make up for the connectionless nature of the UDP, without having to abandon the UDP.

The Japanese patent application No. JP-0206882 describes a network management system where management information is added to a trap when it is transmitted to the manager. If there is any inconsistency between previously received management information and currently added management value a trap resend request is sent to the agent from the manager. One problem with such a solution is that when several trap messages are requested from the agent each lost trap message will have to be requested and retransmitted as a separate messages, which in turn will require additional transmission capacity.

A further problem is that if the manager wants to read and find the last entry in a table of an agent this has to be done by scanning through the table. This, however, in e.g. a re-start of the manager may lead to an unnecessary amount of data traffic on the net.

### SUMMARY OF THE INVENTION

It is an object of the present invention to provide a method and a system, which overcomes the problems as outlined above, and makes up for the connectionless nature of the UDP.

This object is obtained by means of defining a trap table in the MIB structure. A MIB is a structure that describes particular devices being monitored, i.e. its name, syntax, accessibility, status, variables, a text description, etc. The trap table according to the invention comprises the data sent in the trap messages to the manager. The data is stored in the table consecutively.

According to the invention each trap transmitted from the agent to the manager is given an incremental number so that if the manager does not receive all traps, the manager knows which trap(s) to request from the agent using an SNMP get-request message. The information comprised in the specific trap message can then be fetched from the trap table in the agent and transmitted in a response message to the manager. The entire procedure is preferably software implemented.

It is a further object to provide a method and a system in which, the manager will have immediate access to the last trap sent.

According to the invention this is solved by providing a trap counter Without the use of the method etc. according to the invention the manager would have to scan all of the sent trap messages from the first message sent (since the last upstart or the equivalent) until it finds the last of the saved messages, i.e. the last sent message, in the table comprising the sent trap messages, which in turn will require additional transmission capacity. This being the case if the connection between the manager agent or agent—manager has been disrupted for some reason.

This object is according to the invention is thus attained by defining a trap counter in the MIB. The agent, on transmission of the trap, not only stores the trap data in the trap table but it also stores the corresponding trap number in the trap counter in the agent.

The manager can fetch the value of the trap counter from the agent. This allows the manager to retrieve all missing trap(s) in one SNMP get-bulk request. This would not be possible if the manager did not know the trap number of the last sent trap in the trap table, i.e. the value of the trap counter.

### BRIEF DESCRIPTION OF THE DRAWINGS

The present invention will now be described in more detail by way of non-limiting examples and with reference to the accompanying drawings, in which:

FIG. 1 shows a generalized diagram illustrating the IP/TCP alt. UDP combination

FIG. 2 shows a general view of a system according to the invention for managing power supply units in a telecommunications system.

FIG. 3a is a flow chart illustrating the procedural steps carried out when re-transmitting information in the system in FIG. 1.

FIG. 3b is a flow chart illustrating the procedural steps carried out, e.g. upon restart of the manager or on not having received traps for a predetermined time period using the trap counter according to the invention.

### DESCRIPTION OF PREFERRED EMBODIMENTS

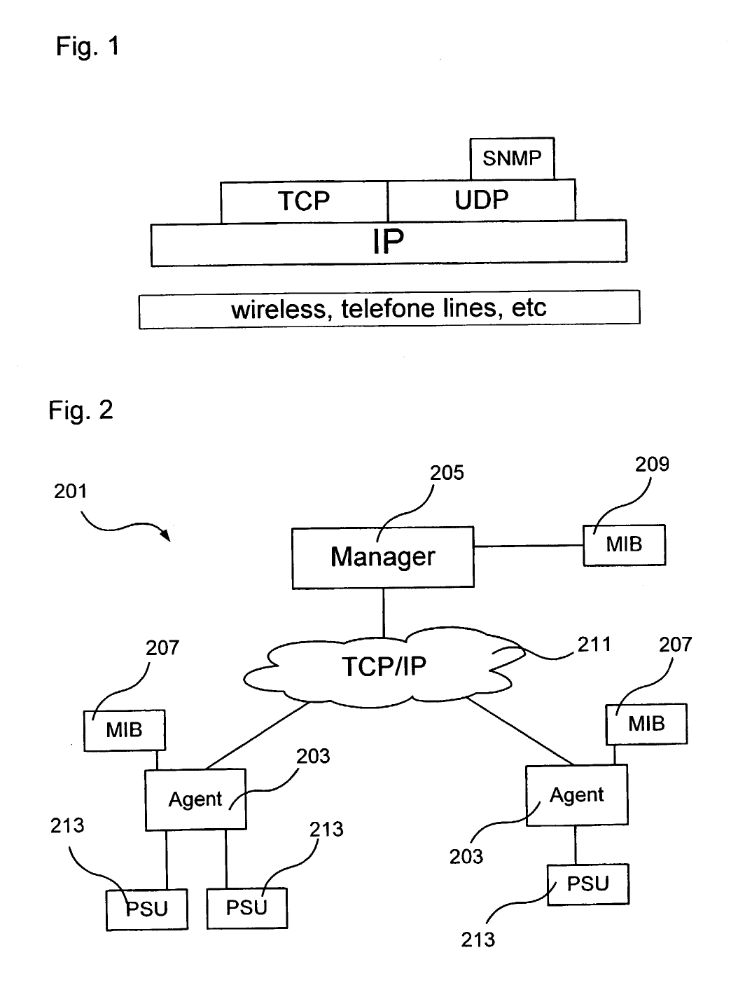

In FIG. 1 is illustrated the combinations IP/TCP and IP/UDP protocols. According to the invention the information is forwarded between manager and agent essentially via the IP (Internet Protocol). The relation TCP, UDP is shown in relation to the IP protocol. Further is seen that the SNMP Protocol is based on UDP. This shows that the reason for using UDP is the use of SNMP.

In FIG. 2, a management system 201 comprising a number of different agents 203 is shown. The system in FIG. 2 is according to the invention intended to be used for managing power supply units in a telecommunications system.

Further, the agents 203 are connected to a common manager unit 205 via a TCP/IP network 211 using SNMP for transmitting UDP messages to and from the agents to the manager unit. UDP refers to User Datagram Protocol. Here TCP/IP should be interpreted in the wide sense, such as to include UDP on the same level as TCP, see FIG. 1.

Further, each agent 203 has a Management Information Base (MIB) 207. Each MIB specifies a table used for storing information about each trap message transmitted from the agent. The manager also has a corresponding MIB 209, comprising an exact copy of the agents 203 MIBs 207.

The agents 203 are shown to manage/supervise one or more Power Supply Units PSU 213. Such a PSU, may comprise such as batteries, rectifiers, distribution units etc. Such a unit may also in itself be its own agent.

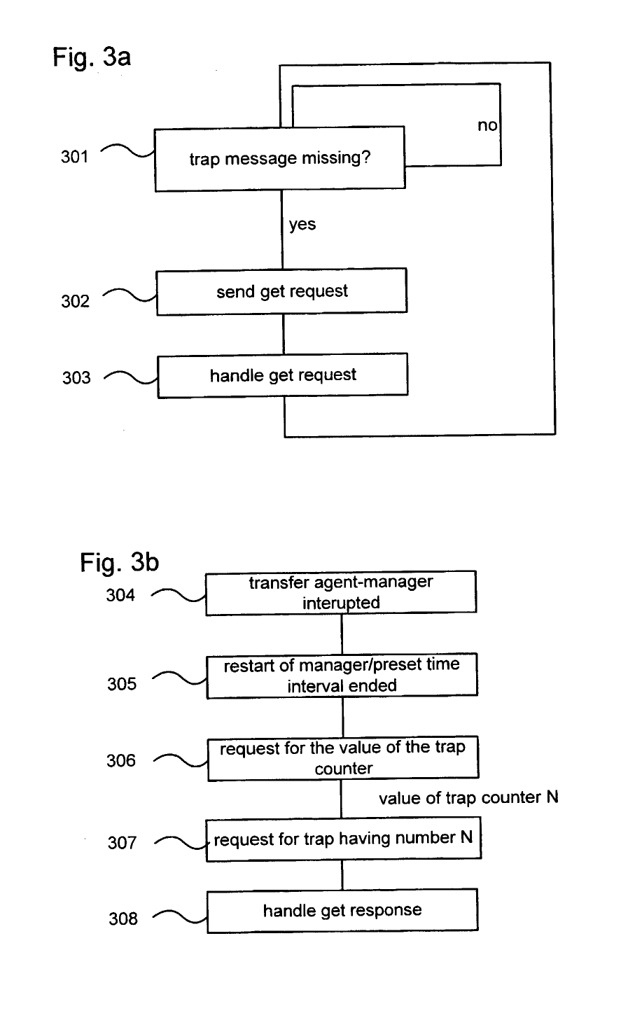

In FIG. 3a, a block scheme illustrating the fetching of information in a trap message transmitted from an agent to the manager and which has been lost, is shown.

Thus, first in a step 301, it is checked if a trap message from a particular agent is missing. This can be carried out in a number of different ways. For example, if the numbered trap messages arrives out-of-order and the missing trap message is not received within a first pre-set time, it is likely that trap messages in between will never arrive. Hence, if the manager has received trap message number 1,2,3 and then receives message number 6, and the messages 4 and 5 does not arrive within the first pre-set time, it is likely that the messages number 4 and 5 never will arrive.

If, in step 301 it is determined that, according to any predetermined criteria, it is likely that there is a trap message missing from a particular agent, the manager issues an SNMP get-request message 302 towards that particular agent, requesting the information of a particular trap message. In step 303 the requested trap is received and handled, i.e. depending on the content and the variables contained in the trap message the manager may act in one way or the other. E.g. an alarm may be sent.

In FIG. 3b is shown a block diagram according to the second embodiment of the invention. In block 304 is indicated the event of an interruption in the transfer manager agent. This will be followed by a restart of the manager in block 305. Bock 305 also covers the eventuality of no trap messages have been received for a predetermined time period for other reasons. This indicates that the preset time period may be exceeded for other technical reasons than a interruption of the transfer.

The manager then in both cases request from the agent the value of the stored trap counter in step 306. The value N is sent in a trap response message to the manager. and the manager in turn can fetch the last trap(s) in a get-bulk request in step 307.

For example, if the manager has received the trap messages 1,2,3,4,5 and 6 and has not received any trap messages during a pre-determined time after receiving the trap message number 6, the manager transmits a request fetching the trap number N. Thereafter the manager may request trap messages having a number 7-N to be resent.

Thus by providing a trap table defined in the MIB and the provision of an associated trap number the possibility of fetching exactly the missing trap message.

Further by providing the trap counter defined in the MIB having information as to the number of the last sent trap the possibility arises of fetching all missing trap messages in on get-bulk request.

The advantage of a method according to the first embodiment of the invention compared to for example the method disclosed in the Japanese patent application No. JP-0206882 is that only one response message needs to be transmitted from the agent to the manager even if there are several trap messages that has to be transmitted, since all information in the missing trap messages can be placed in one single get-response message, whereas, if the method as described in the Japanese patent application No. JP-0206882 is used several messages has to be transmitted, one for each missing trap message. This is advantageous because the overhead information will be reduced and transmission capacity will be saved.

This of course also holds true for the second embodiment described above. The second embodiment is even more advantageous as the data traffic may be even more limited.

Thus, the agent, as a response to the get-request message, returns the information in the trap table defined by the MIB corresponding to the get-request message using a get-response message.

If, in any case, no response is received in the manager during a pre-set time interval, a new request is transmitted to the agent requesting the same information, or an alarm is triggered in the manager.

The use of the method and the system as described herein, provides a synchronization of the UDP protocol, so that trap messages transmitted from an agent to a manager cannot be lost and at the same time makes it possible to obtain this without having to retransmit each missing trap message as a separate message. Also the manager can find out which was the last trap message sent and request all missing traps in one request.

1. A method of providing synchronization, in an SNMP based management network for power supply units in a telecommunication system, between an agent and a manager, where the agent has a MIB comprising a definition of a trap table for storing information regarding information transmitted from the agent to the manager as trap messages using a User Datagram Protocol (UDP), characterized by the steps of:
assigning to each trap message sent from the agent a trap number and storing said number;
controlling in the manager the receipt of consecutive traps;
transmitting a get-request message from the manager to the agent requesting trap message information associated with a particular trap number or several trap numbers missing or not complete;
in the agent, fetching from the trap table the trap message information associated with the assigned trap number(s), and
as a response to the get-request message, transmitting a get-response message from the agent to the manager comprising the trap message information fetched from the trap table of the agent

2. A method according to claim 1, characterized in that the get-request message only is transmitted to the agent if information is determined to be missing or likely to be missing according to any suitable algorithm used by the manager.

3. A method according to claims 1 to 2, characterized in that a trap counter is provided in each agent for storing the trap number assigned to the last sent trap message, said trap counter defined in the MIB.

4. A method according to any of the proceeding claims characterized in that the manager on the loss of information due to up-start etc. retrieves from the agent the trap number of the last trap message fetched from the agent's trap counter.

5. A computer program, which when run on a computer, performs the following steps in a synchronization method, in an SNMP based management network for power supply units in a telecommunication system, between an agent and a manager, where the agent has a MIB defining a trap table for storing information regarding information transmitted from the agent to the manager as trap messages using a User Datagram Protocol (UDP):
assigning to each trap message sent from the agent a trap number and storing said number;
controlling in the manager the receipt of consecutive traps;
transmitting a get-request message from the manager to the agent requesting trap message information associated with a particular trap number or several trap numbers missing or not complete;
in the agent, fetching from the trap table in the agent the trap message information associated with the assigned trap number(s), and
as a response to the get-request message, transmitting a get-response message from the agent to the manager comprising the trap message information fetched from the trap table of the agent.

6. A computer program according to claim 5 in which the further step of storing the present trap number in a trap counter in connection with a trap message being sent.

7. A system providing synchronization, in an SNMP based management network for power supply units in a telecommunication system, between an agent and a manager, where the agent has a MIB defining a trap table for storing information regarding information transmitted from the agent to the manager as trap messages using a User Datagram Protocol (UDP);
means for transmitting a get-request message from the manager to the agent requesting the information associated with a particular trap number or several trap numbers;
in the agent, means for fetching from the trap table in the agent the trap message information associated with the trap number(s), and
means for transmitting a get-response message from the agent to the manager comprising the trap message information fetched from the trap table as a response to the get-request message.

8. A system according to claim 7 , characterized by means for transmitting the get-request message to the agent only if information is determined to be missing or likely to be missing according to any suitable algorithm used by the manager.

9. A system according to any of the claims 7 to 8, characterized by each agent being provided with a trap counter to be updated as to the trap number of the last transmitted trap message, said trap counter defined in the MIB.
